(19) United States
(12) Patent Application Publication
(10) Pub. No.: US 2025/0360439 A1
(43) Pub. Date: Nov. 27, 2025

(54) FILTER DEVICE AND FILTRATION DEVICE

(71) Applicant: YAMASHIN-FILTER CORP., Kanagawa (JP)

(72) Inventors: Nobuyuki KITAJIMA, Kanagawa (JP); Shigeru HASHIMOTO, Kanagawa (JP); Mitsunobu OKAMOTO, Kanagawa (JP); Hideo NAKAOKA, Kanagawa (JP); Yuji UCHIYAMA, Kanagawa (JP)

(21) Appl. No.: 19/294,474

(22) Filed: Aug. 8, 2025

Related U.S. Application Data
(63) Continuation of application No. PCT/JP2024/008712, filed on Mar. 7, 2024.

(30) Foreign Application Priority Data
Mar. 10, 2023 (JP) 2023-037766

(51) Int. Cl. B01D 29/58; B01D 29/11; B01D 35/027; B01D 35/147; B01D 35/30; B01D 36/00

(52) U.S. Cl. CPC B01D 29/58; B01D 29/114; B01D 29/117; B01D 35/027; B01D 35/1475; B01D 35/30; B01D 36/001

(57) ABSTRACT

A filter device includes: a first filtration unit; a second filtration unit provided below the first filtration unit to overlap the first filtration unit in plan view; and a third filtration unit provided in the first filtration unit or the second filtration unit. The first filtration unit includes: a case; a first inflow portion through which a fluid flows into the case; a first filter element having a tubular shape and disposed inside the case; and a first outflow portion including a first flow path through which the filtered fluid filtered by the first filter element flows out from the first filtration unit.

### CROSS-REFERENCE TO RELATED APPLICATIONS

This application is a continuation application of International Patent Application No. PCT/JP2024/008712 filed on Mar. 7, 2024, which claims priority to Japanese Patent Application No. 2023-037766 filed on Mar. 10, 2023, the entire contents of which are incorporated by reference.

### TECHNICAL FIELD

The present invention relates to a filter device and a filtration device.

### BACKGROUND ART

Patent Document 1 discloses a filter device including: a bottomed tubular filter case attached to a tank in which a liquid is stored and having an open upper end; a filter element provided inside the filter case and including a first filtration member having a tubular shape; a lid provided on the filter case and the filter element so as to cover the upper end of the filter case, the lid including an air vent hole allowing communication between a space inside the filter element and a space outside the filter case; an inflow portion through which the liquid flows into the filter case and into the space outside the filter element; an outflow portion allowing communication between the space inside the filter element and the space outside the filter case; and a back pressure valve provided in the outflow portion.

### CITATION LIST

### Patent Literature

Patent Document 1: International Publication No. 2020/218357

According to Patent Document 1, the back pressure valve is brought into a closed state during idling, and the back pressure valve is brought into an open state only when an engine is operated, and thus air (initial air) inside the filter case is prevented from flowing out from the outflow portion before the engine is operated. However, in the invention described in Patent Document 1, when air bubbles are contained in a hydraulic oil flowing into the filter device after the engine is operated, it is difficult to remove the air bubbles.

### SUMMARY OF INVENTION

The present invention is to provide a filter device and a filtration device that can prevent the outflow of air bubbles contained in a fluid.

A filter device according to one or more aspects of the present invention includes: for example, a first filtration unit; a second filtration unit provided below the first filtration unit to overlap the first filtration unit in plan view; and a third filtration unit provided in the first filtration unit or the second filtration unit. The first filtration unit includes: a case; a first inflow portion provided in the case and through which a fluid flows into the case; a first filter element through which the fluid passes and thus is filtered and the first filter element having a tubular shape and disposed inside the case; and a first outflow portion provided in the case and including a first flow path through which the fluid filtered by the first filter element flows out from the first filtration unit. The second filtration unit includes: a second filter element having a tubular shape and disposed inside a tank; a second inflow portion provided between the first outflow portion and the second filter element and including a second flow path that allows the first flow path and a hollow portion of the second filter element to communicate with each other; and a second outflow portion provided below the second filter element and including a third flow path that allows the hollow portion of the second filter element and an outside of the second filter element to communicate with each other. The third filtration unit includes a filtration part that covers at least one of the first flow path, the second flow path, or the third flow path.

In addition, a filter according to one or more aspects of the present invention includes: for example, a tank; a first filtration unit provided to protrude from an upper surface of the tank into the tank; a second filtration unit provided below the first filtration unit to overlap the first filtration unit in plan view; a third filtration unit provided in the first filtration unit or the second filtration unit. The filtration unit includes: a case; a first inflow portion provided in the case and through which a fluid flows into the case; a first filter element having a tubular shape and disposed inside the case, the first filter through which the fluid passes to be filtered; and a first outflow portion provided in the case and including a first flow path through which the filtered fluid filtered by the first filter element flows out from the first filtration unit. The second filtration unit includes: a second filter element having a tubular shape and disposed inside the tank; a second inflow portion provided between the first outflow portion and the second filter element and including a second flow path that allows the first flow path and a hollow portion of the second filter element to communicate with each other; and a second outflow portion provided below the second filter element and including a third flow path that allows the hollow portion of the second filter element and an outside of the second filtration unit to communicate with each other. The third filtration unit includes a filtration part that covers at least one of the first flow path, the second flow path, or the third flow path.

According to the filter device according to one or more aspects of the present invention, the third filtration unit including the filtration part is provided to cover at least one of the first flow path, the second flow path, or the third flow path. Accordingly, since air bubbles are removed when the fluid passes through the third filtration unit, the air bubbles contained in the fluid can be prevented from flowing out from the filter device.

The second filtration unit may include an upper end member provided on an upper end side of the second filter element,
the second flow path may be formed in the upper end member, and
the third filtration unit may be formed of a net-like member having a plate shape and may be provided on the upper end member to cover the second flow path. This enables the structure of the filter device to be simplified.

The second outflow portion may include a lower end member provided on a lower end side of the second filter element,
the third flow path may be formed in the lower end member, and
the third filtration unit may be provided in a hollow portion of the second filtration unit to cover the third flow path. Since the hollow portion of the second filtration unit is wide, the flexibility in shape of the third filtration unit is increased.

The filtration part may be a member obtained by forming a net-like member into a tubular shape, the third filtration unit may include a plate covering one end of the filtration part, and an end of the filtration part on a side at which the plate is not disposed may be provided on the lower end member. This enables the filtration area of the third filtration unit to be increased.

The filter device may include an exhaust pressure valve provided in the first filtration unit or the second filtration unit, the case may include a filter case and a lid member at which an upper side of the filter case is provided, and
the lid member may include the first inflow portion and a third outflow portion through which a hydraulic oil flowing through the first inflow portion to an inner part of the lid member flows out. This allows the fluid flow to be changed in accordance with the pressure inside the filter device.

According to one or more aspects of the present invention, the outflow of air bubbles contained in the fluid can be prevented.

### BRIEF DESCRIPTION OF DRAWINGS

FIG. 1 is a diagram illustrating an overview of a tank 100 in which a filter device 1 according to an embodiment of the present invention is provided.

FIG. 2 is a cross-sectional view illustrating an overview of the filter device 1.

FIG. 3 is a cross-sectional view illustrating the overview of the filter device 1, and is an enlarged view of main parts thereof.

FIG. 4 is a cross-sectional view illustrating an overview of a filter device 1A.

FIG. 5 is a cross-sectional view illustrating an overview of a filter device 1B.

FIG. 6 is a cross-sectional view illustrating an overview of a filter device 2.

FIG. 7 is a cross-sectional view illustrating the overview of the filter device 2, and is an enlarged view of main parts thereof.

FIG. 8 is a cross-sectional view illustrating an overview of a filter device 2A.

FIG. 9 is a cross-sectional view illustrating an overview of a filter device 3.

FIG. 10 is a cross-sectional view illustrating an overview of a filter device 4.

FIG. 11 is a cross-sectional view illustrating an overview of a filter device 4A.

FIG. 12 is a cross-sectional view illustrating an overview of a filter device 4B.

FIG. 13 is a cross-sectional view illustrating an overview of a filter device 5.

FIG. 14 is a cross-sectional view illustrating an overview of a filter device 5A.

FIG. 15 is a cross-sectional view illustrating an overview of a filter device 6.

### DESCRIPTION OF EMBODIMENTS

Embodiments of the present invention will be described below in detail with reference to the drawings. A filter device of the present invention is provided in a hydraulic circuit for a hydraulic oil supplied to a hydraulic device of a work machine (a hydraulic shovel, a wheel loader, or the like), and filters the hydraulic oil. However, a location in which the filter device of the present invention is provided is not limited to a hydraulic circuit, and the fluid filtered by the filter device is not limited to a hydraulic oil. In addition, the present invention can be provided not only as a filter device but also as a filtration device provided in a tank.

### First Embodiment

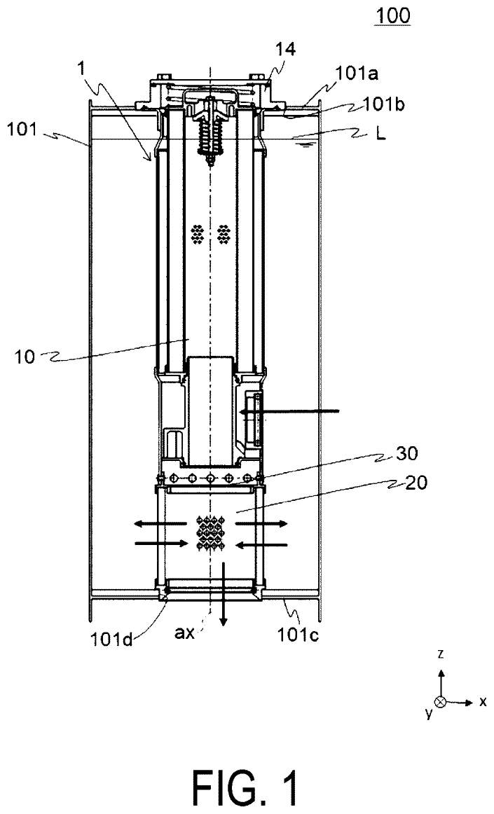

FIG. 1 is a diagram illustrating an overview of a tank 100 in which a filter device 1 according to an embodiment of the present invention is provided. In FIG. 1, main parts of the tank 100 are illustrated in a perspective view, and some parts are illustrated in a cross-sectional view (however, hatching indicating a cross-section is omitted).

The tank 100 is provided in a hydraulic circuit for a hydraulic oil and in which a hydraulic oil L is stored. In the hydraulic circuit, the hydraulic oil L passes through the hydraulic device to be introduced into the tank 100.

The tank 100 includes, for example, a tank body 101 having a box shape, and the tank body 101 has a hollow inside. The inside of the tank body 101 is mainly provided with the filter device 1.

A hole 101b into which the filter device 1 is inserted is formed in an upper surface 101a of the tank body 101. A lid member 14 and the like (described below in detail) of the filter device 1 is provided on a top face of the upper surface 101a, and thus the filter device 1 is fixed to the tank body 101.

The filter device 1 mainly includes a first filtration unit 10, a second filtration unit 20, and a third filtration unit 30.

The second filtration unit 20 is provided below the first filtration unit 10 to overlap the first filtration unit 10 in plan view (when viewed from a z-direction). The second filtration unit 20 is provided near a bottom surface 101c of the tank body 101. The third filtration unit 30 is provided in the first filtration unit 10 or the second filtration unit 20.

The first filtration unit 10 and the second filtration unit 20 have substantially the same orientation for a central axis ax along the z-direction. In the present embodiment, the central axes ax of the first filtration unit 10, the second filtration unit 20, and the third filtration unit 30 match, but these need not match.

A hole 101d is formed in the bottom surface 101c of the tank body 101. A lower end portion of the second filtration unit 20 is inserted into the hole 101d.

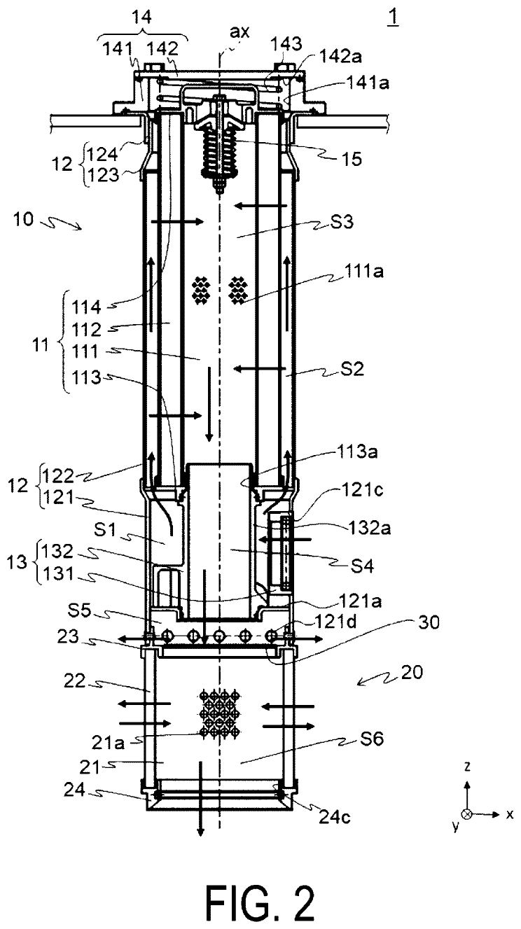

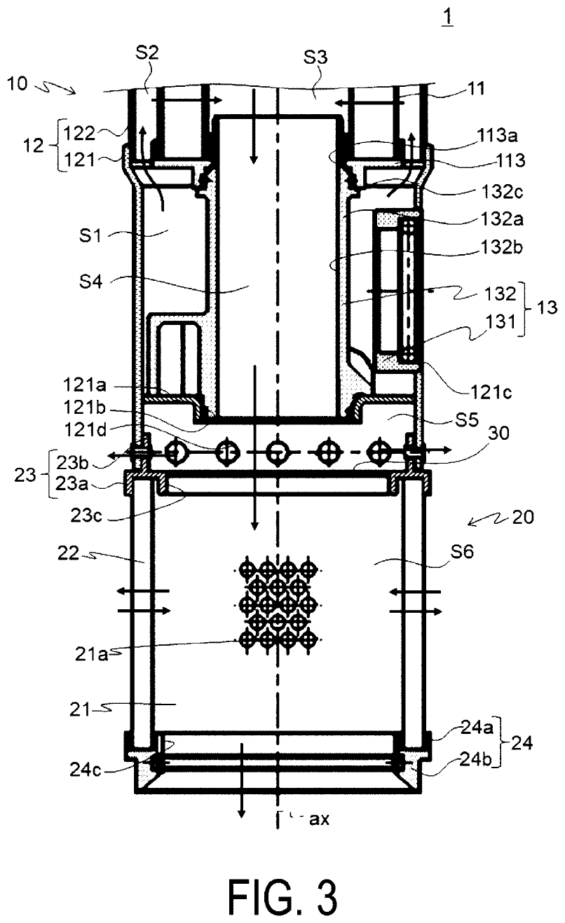

FIG. 2 is a cross-sectional view illustrating an overview of the filter device 1. FIG. 3 is a cross-sectional view illustrating the overview of the filter device 1, and is an enlarged view of main parts thereof. In FIG. 2, hatching indicating a cross-section is omitted.

The first filtration unit 10 includes a filter element 11, a filter case 12, an inner part 13, the lid member 14, and a valve 15.

The filter element 11 (first filter element of the present invention) is a member having a tubular shape (here, a cylindrical shape) as a whole and is provided inside the filter case 12. The filter element 11 is configured to filter a hydraulic oil when the hydraulic oil passes through the filter element 11. The filter element 11 mainly includes an inner tube 111, a filtration member 112, and plates 113 and 114.

The filtration member 112 is configured to filtrate the hydraulic oil, and has a substantially cylindrical shape with a thickness in a radial direction. The filtration member 112 is formed by pleating a filter paper formed of a synthetic resin, paper, or the like, and connecting both ends of the pleated filter paper and rolling the paper into a cylindrical shape.

The inner tube 111 is a substantially cylindrical member made of metal and is provided inside the filtration member 112. The height of the inner tube 111 is substantially the same as the height of the filtration member 112. A hole 111a through which the hydraulic oil passes is formed in the inner tube 111 substantially over the entire surface.

The plate 113 is provided on lower ends of the inner tube 111 and the filtration member 112, and the plate 114 is provided on upper ends of the inner tube 111 and the filtration member 112. The plate 113 and the plate 114 are members having a substantially circular plate shape or a bottomed substantially cylindrical shape, and are formed of resin or metal. The plate 113 has an opening 113a formed substantially in the center.

The plate 114 is provided with the valve 15. The valve 15 is a bypass valve, and opens and closes in accordance with a difference between the pressure inside (in a space S3) of the filter element 11 and the pressure outside thereof (in a space S2).

The filter case 12 is a member having a bottomed substantially cylindrical shape as a whole, and is formed of metal. The lid member 14 is provided on the upper side of the filter case 12. The filter element 11 is provided inside the filter case 12 and the lid member 14 (that correspond to a case of the present invention).

The filter case 12 mainly includes a first case 121, a second case 122, and mounting members 123 and 124. The second case 122 is formed on the upper side of the first case 121 integrally therewith. Note that the mounting members 123 and 124 are not necessarily required.

The first case 121 and the second case 122 are tubular (here, cylindrical) members. The second case 122 is provided on the upper side (+z side) of the first case 121. The second filtration unit 20 is provided on the lower side (−z side) of the first case 121, and the lid member 14 is provided on the upper side of the second case 122.

The inner part 13 is provided inside the first case 121. The inner part 13 is a part of the filter case 12.

The inner part 13 mainly includes a first part 131 and a second part 132. In the present embodiment, the inner part 13 is provided on a plate-like portion 121a disposed in a hollow portion of the first case 121, but the form of providing the inner part 13 inside the first case 121 is not limited thereto.

The second part 132 is provided so as to close the hollow portion of the first case 121, and divides the inside of the first case 121 into three spaces S1, S4, and S5. The space above the plate-like portion 121a and the second part 132 is the space S1, and the space below the plate-like portion 121a and the second part 132 is the space S5.

The first part 131 is provided in the space S1. The first part 131 is provided with an inflow pipe (not illustrated) disposed in a hole 121c formed in a side surface of the first case 121. The first part 131 is an inflow portion (corresponding to a first inflow portion of the present invention) through which the hydraulic oil flows into the filter case 12. The space S1 is a space into which the hydraulic oil L flowing into the filter device 1 from the inflow portion first flows. The hydraulic oil flows from the space S1 into the space S2 that is a space between the first case 121 and the filter element 11.

The second part 132 includes a tubular portion 132a extending along the center axis ax. A hollow portion 132b of the tubular portion 132a extends through the tubular portion 132a, i.e., the second part 132.

A lower end of the tubular portion 132a is inserted into a hole 121b formed in the plate-like portion 121a. In addition, the plate 113 is in contact with a protruding portion 132c provided near an upper end of the tubular portion 132a, and the tubular portion 132a is inserted into the opening 113a, and thus the upper end of the tubular portion 132a is inserted into the filter element 11. Therefore, the hollow portion 132b (the space S4) allows a hollow portion (the space S3) of the filter element 11 and the space (space S5) below the second part 132 of the first case 121 to communicate with each other.

The second part 132 and the first case 121 that form the spaces S4 and S5 (corresponding to a first flow path of the present invention) are an outflow portion (corresponding to a first outflow portion of the present invention) through which the fluid (corresponding to a first outflow portion of the present invention) filtered by the filter element 11 flows out. In addition, a plurality of holes 121d are formed in a portion of the first case 121, which forms the space S5. However, the holes 121d are not necessarily required.

The lid member 14 is a substantially plate-like member that covers an open end of an upper portion of the filter case 12. The lid member 14 is detachably provided on the filter case 12 (here, the mounting member 124).

The lid member 14 includes a first lid 141 and a second lid 142. The first lid 141 has a substantially cylindrical shape, and a hollow portion 141a is formed therein. The second lid 142 has a plate shape and is provided so as to cover the hollow portion 141a. An elastic member 143 is provided between a lower surface 142a of the second lid 142 and the plate 114.

When the lid member 14 (here, the second lid 142) is removed from the filter case 12, the filter element 11 can be pulled out from the open end of the upper portion of the filter case 12. When the lid member 14 is attached to the filter case 12, the elastic member 143 is held between the plate 114 and the second lid 142, and the plate 114, i.e., the filter element 11 is pressed in the −z direction by biasing force of the elastic member 143. As a result, the filter element 11 is provided within the filter case 12.

Note that in the present embodiment, the lid member 14 includes the first lid 141 and the second lid 142, but the form of the lid member 14 is not limited to such a form. For example, the lid member 14 may be a single component.

The second filtration unit 20 is, for example, a suction strainer for preventing entry of foreign substances into a hydraulic pump. The second filtration unit 20 mainly includes a tubular portion 21, a filtration member 22, an upper end member 23, and a lower end member 24.

The tubular portion 21 is a substantially cylindrical member made of metal, and a plurality of holes 21a are formed in a side surface. The filtration member 22 is formed by pleating a wire mesh, which is formed by weaving a metal wire rod, and connecting both ends of the pleated wire mesh and rolling the wire mesh into a cylindrical shape. The filtration member 22 is disposed on the outer side of the tubular portion 21. Note that the tubular portion 21 is not necessarily required. In addition, the form of the filtration member 22 is not limited to such a form.

The upper end member 23 is provided on the upper end side of the tubular portion 21 and the filtration member 22 (that correspond to a second filter element of the present invention). Note that the upper end member 23 may be directly provided on upper ends of the tubular portion 21 and the filtration member 22 or may be provided via a member above the tubular portion 21 and the filtration member 22. The upper end member 23 includes a recessed portion 23a into which the tubular portion 21 and the filtration member 22 are inserted, and a tubular portion 23b provided on the recessed portion 23a. The tubular portion 23b protrudes upward (toward the first filtration unit 10) from the recessed portion 23a, and the tubular portion 23b and the first case 121 are fixed in a state where the tubular portion 23b is inserted into the first case 121. As a result, the first case 121 is disposed on the upper end member 23. However, the form of providing the first case 121 on the upper end member 23 is not limited to such a form.

A hollow portion 23c (corresponding to a second flow path of the present invention) of the recessed portion 23a allows the space S4 (the hollow portion 132b) and a hollow portion (a space S6) of the filtration member 22 to communicate with each other, and the fluid filtered by the filter element 11 passes through the hollow portion 23c.

The lower end member 24 is disposed on the lower end side of the tubular portion 21 and the filtration member 22. Note that the lower end member 24 may be directly provided at lower ends of the tubular portion 21 and the filtration member 22 or may be provided via a member below the tubular portion 21 and the filtration member 22. The lower end member 24 includes a recessed portion 24a into which the tubular portion 21 and the filtration member 22 are inserted, and a tubular portion 24b inserted into the hole 101d of the tank 100. A hollow portion 24c (corresponding to a third flow path of the present invention) of the lower end member 24 allows the hollow portion of the filtration member 22 and the outside of the second filtration unit to communicate with each other.

The third filtration unit 30 is a plate-like filtration part formed of a wire mesh formed by weaving metal wires. The third filtration unit 30 is provided on the upper end member 23 so as to cover the hollow portion 23c. The mesh of the wire mesh constituting the filtration part of the third filtration unit 30 is as fine as the mesh of the filtration member 22 or finer than the mesh of the filtration member 22.

Note that the filtration part constituting the third filtration unit 30 only needs to be a net-like member and is not limited to a wire mesh. For example, the filtration part of the third filtration unit 30 may be a mesh formed in a spider web shape or a net-like pattern formed by weaving a resin wire rod or attaching a resin wire rod, or may be a net formed by knitting strings or the like. The net-like member of the present invention is a concept including these wire nets, meshes, netting, or the like. Further, the third filtration unit 30 may be provided with another member (for example, a hollow disk-shaped member) on the peripheral edge of the filtration part formed of the net-like member. Furthermore, the third filtration unit 30 is not limited to a flat plate. The third filtration unit 30 only needs to have a plate shape, and examples of the plate shape include a plate having a curve (for example, a wave shape), a plate having recessed and protruding portions, a plate curved in a basket (bowl) shape, and the like.

Next, a function of the filter device 1 configured as just described will be described with reference to FIGS. 2 and 3. Arrows in FIGS. 2 and 3 indicate the flow of hydraulic oil.

The hydraulic oil flows through the hydraulic circuit during operation of the hydraulic device. The hydraulic oil flows through the first part 131 into the space S1. The hydraulic oil flows from the space S1 into the space (space S2) outside the filter element 11 and flows from the outer side toward the inner side of the filter element 11, thereby being filtered and flowing into the space S3. The filtered hydraulic oil flows downward from the space S3 into the spaces S4 and S5.

Apart of the hydraulic oil flowing into the space S5 flows out into the tank 100 through the holes 121d depending on the flow volume, but a large part of the hydraulic oil flows into the space S6. At this time, the hydraulic oil passes through the third filtration unit 30.

Since the third filtration unit 30 is formed of a wire mesh, the hydraulic oil can pass through the third filtration unit 30. However, air bubbles can hardly pass through the third filtration unit 30, and in particular, large air bubbles cannot pass through the third filtration unit 30. Therefore, the air bubbles are removed from the hydraulic oil.

A part of the hydraulic oil passing through the third filtration unit 30 and then flowing into the space S6 flows out into the tank 100 via the filtration member 22 or flows in from the tank 100 depending on the flow volume; however, a large part of the hydraulic oil flows out from the filter device 1 through the hollow portion 24c. The hydraulic oil flowing out from the filter device 1 is guided to a pump of the hydraulic circuit.

When filtration is repeated, clogging of the filtration member 112 occurs, and thus the filter element 11 is replaced. The lid member 14 is removed from the filter case 12, and then the filter element 11 is pulled out upward. As a result, the filter element 11 is pulled out from the open end of the upper portion of the filter case 12. Thereafter, a new filter element 11 after replacement is inserted from the open end of the upper portion of the filter case 12, and the lid member 14 is attached to the filter case 12. Accordingly, the new filter element 11 is disposed inside the filter case 12 and the lid member 14.

According to the present embodiment, the third filtration unit 30 is provided so as to cover the hollow portion 23c, and thus the outflow of air bubbles contained in the hydraulic oil can be prevented. In addition, the third filtration unit 30 is formed in a plate shape and is provided on the upper end member 23; therefore, the structure of the filter device 1 can be simplified. When the structure is complicated, defects are likely to occur during manufacturing or while in use; however, the defects can be made less likely to occur by simplifying the structure of the filter device 1.

In the present embodiment, the third filtration unit 30 is formed of a plate-like wire mesh (filtration part), but the form of the third filtration unit 30 is not limited such a form. For example, a member in which holes are formed in a plate-like member and the holes are covered with a plate-like wire mesh (filtration part) may be applied as the third filtration unit 30.

Further, in the present embodiment, the third filtration unit 30 is provided on the second filtration unit 20 so as to cover the hollow portion 23c; however, the position in which the third filtration unit 30 is provided is not limited to such a position. For example, the third filtration unit 30 may be provided in the first filtration unit 10 so as to cover the hole 121b.

Furthermore, in the present embodiment, the third filtration unit 30 formed of a plate-like metal mesh is provided so as to cover the hollow portion 23c; however, the form in which the third filtration unit 30 is provided so as to cover the hollow portion 23c is not limited to such a form. For example, a third filtration unit including a filtration part formed of steel wool or the like may be inserted into the hollow portion 23c. In this case, air bubbles are captured by the filtration part; therefore, the air bubbles can be prevented from being discharged. However, air bubbles captured by the filtration part when the flow rate increases are likely to be discharged together with the hydraulic oil; therefore, it is desirable that a net-like member through which the air bubbles can hardly pass is used in the third filtration unit 30.

Additionally, in the present embodiment, the entire filter device 1 is provided inside the tank 100; however, the form of the tank 100 is not limited to such a form. For example, only a portion of the filter device 1, which is located below the plate-like portion 121a may be provided inside the tank 100. Moreover, when the holes 121d are not provided, only the second filtration unit may be provided inside the tank 100.

### First Modified Example of First Embodiment

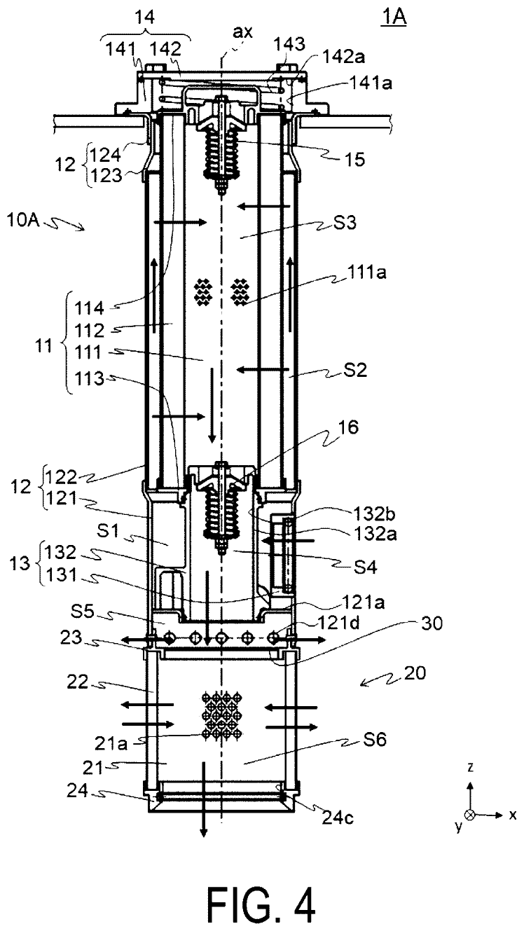

FIG. 4 is a cross-sectional view illustrating an overview of a filter device 1A according to a modified example. The filter device 1A is different from the filter device 1 in that an exhaust pressure valve 16 is provided. In FIG. 4, hatching indicating a cross-section is omitted. Note that descriptions of the same components as those in the filter device 1 will be omitted.

The filter device 1A mainly includes a first filtration unit 10A, the second filtration unit 20, and the third filtration unit 30. The first filtration unit 10A includes the filter element 11, the filter case 12, the inner part 13, the lid member 14, the valve 15, and the exhaust pressure valve 16.

The exhaust pressure valve 16 is provided in the second part 132 so as to cover the hollow portion 132b. The exhaust pressure valve 16 opens when the pressure in the spaces S1 to S3 reaches a set pressure, and allows the hydraulic oil to flow from the space S3 into the space S4. Therefore, when the flow volume of the hydraulic oil is small during idling or the like, the exhaust pressure valve 16 does not open.

The provision of the exhaust pressure valve 16 allows the oil filtered in the filter device 1A to flow to the pump at a constant pressure when the flow volume increases during operation of the hydraulic device.

### Second Modified Example of First Embodiment

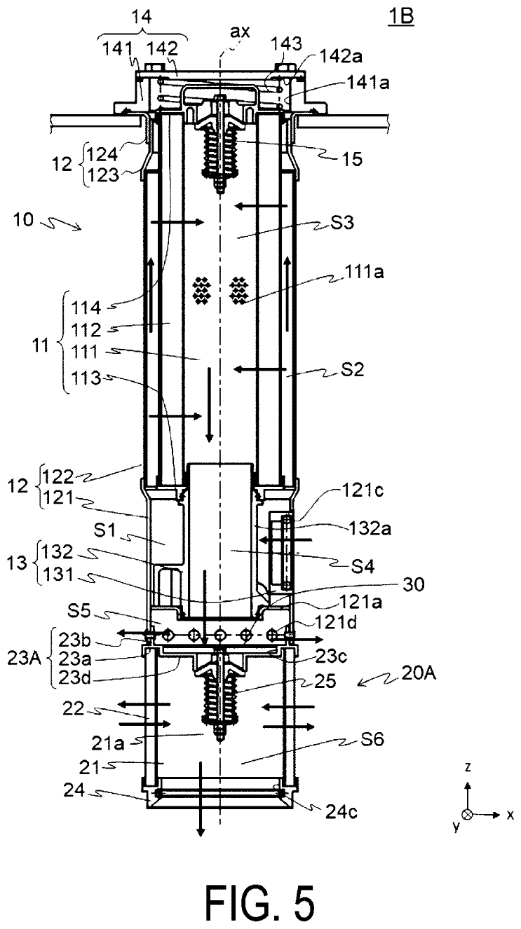

FIG. 5 is a cross-sectional view illustrating an overview of a filter device 1B according to a modified example. The filter device 1B is different from the filter device 1 in that an exhaust pressure valve 25 is provided. In FIG. 5, hatching indicating a cross-section is omitted. Note that descriptions of the same components as those in the filter device 1 will be omitted.

The filter device 1B mainly includes the first filtration unit 10, a second filtration unit 20A, and the third filtration unit 30. The second filtration unit 20A mainly includes the tubular portion 21, the filtration member 22, an upper end member 23A, the lower end member 24, and the exhaust pressure valve 25.

The upper end member 23A is provided on the upper ends of the tubular portion 21 and the filtration member 22. The upper end member 23 includes the recessed portion 23a into which the tubular portion 21 and the filtration member 22 are inserted, the tubular portion 23b provided on the recessed portion 23a, and a mounting portion 23d. The mounting portion 23d is a member to which the exhaust pressure valve 25 is mounted, and is provided in the hollow portion 23c.

The exhaust pressure valve 25 opens when the pressure in the spaces S1 to S5 reaches a set pressure, and allows the hydraulic oil to flow from the space S5 into the space S6. Therefore, when the flow volume of the hydraulic oil is small during idling or the like, the exhaust pressure valve 25 is closed, and the mounting portion 23d and the exhaust pressure valve 25 cover the hollow portion 23c.

The provision of the exhaust pressure valve 25 allows the oil filtered in the filter device 1B to flow to the pump at a constant pressure when the flow volume increases during operation of the hydraulic device.

### Second Embodiment

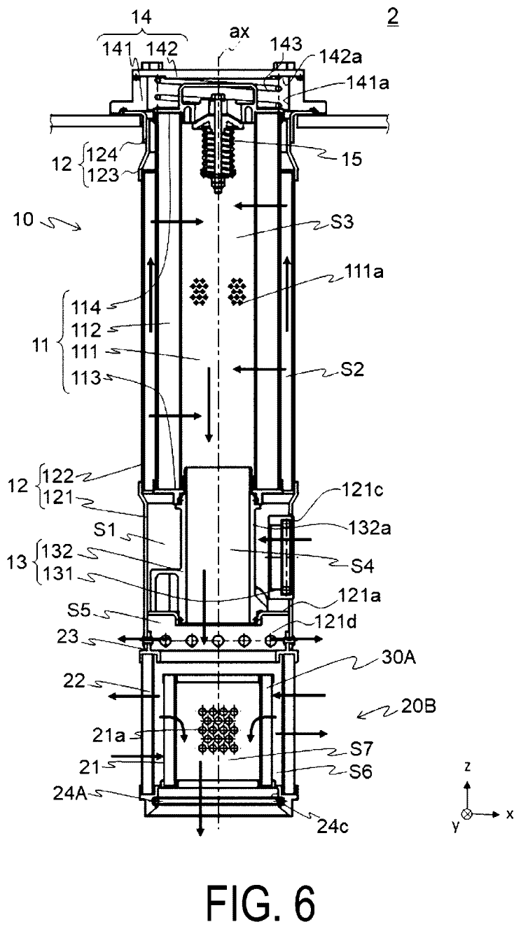

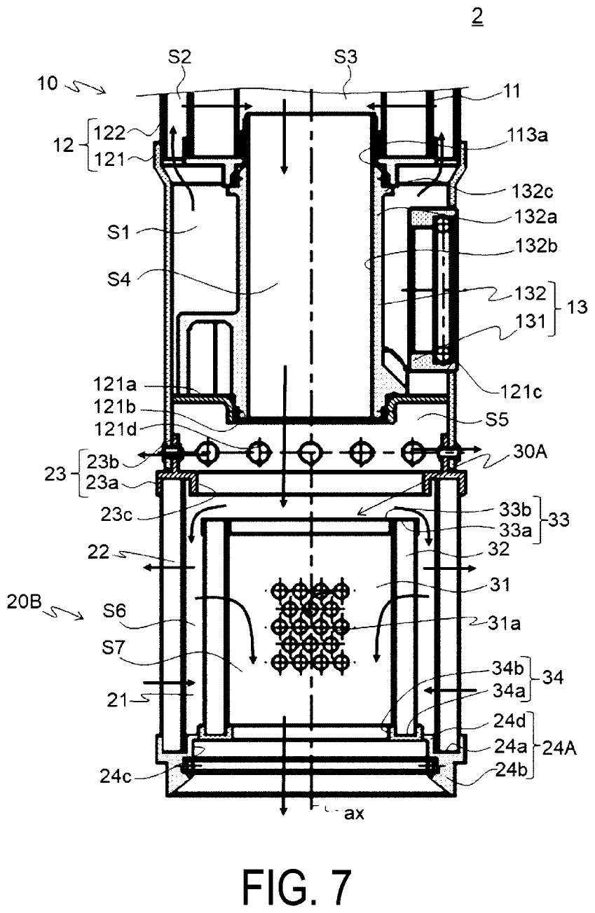

FIG. 6 is a cross-sectional view illustrating an overview of a filter device 2 according to a second embodiment. FIG. 7 is a cross-sectional view illustrating the overview of the filter device 2, and is an enlarged view of main parts thereof. In FIG. 6, hatching indicating a cross-section is omitted. Note that descriptions of the same components as those in the filter device 1 will be omitted.

The filter device 2 mainly includes the first filtration unit 10, a second filtration unit 20B, and a third filtration unit 30A. The third filtration unit 30A is provided in the hollow portion (space S6) of the second filtration unit 20B.

The second filtration unit 20B mainly includes the tubular portion 21, the filtration member 22, the upper end member 23, and a lower end member 24A.

The lower end member 24A is provided at the lower ends of the tubular portion 21 and the filtration member 22. The lower end member 24 includes the recessed portion 24a, the tubular portion 24b, and a mounting portion 24d. The mounting portion 24d is formed at an upper end of the tubular portion 24b, and the third filtration unit 30A is provided thereon. However, the form of mounting the third filtration unit 30A to the lower end member 24A is not limited to such a form.

The third filtration unit 30A is provided so as to cover the hollow portion 24c. The third filtration unit 30A mainly includes a tubular portion 31, a filtration member 32, an upper end member 33, and a lower end member 34.

The tubular portion 31 is a substantially cylindrical member made of metal, and a plurality of holes 31a are formed in a side surface. The filtration member 32 is a filtration member (so-called pleated filtration member) formed by pleating a wire mesh, which is formed by weaving a metal wire rod, and connecting both ends of the pleated wire mesh and rolling the wire mesh into a cylindrical shape. The filtration member 32 is provided on the outer side of the tubular portion 31. The mesh of the filtration member 32 is as fine as the mesh of the filtration member 22 or finer than the mesh of the filtration member 22.

Note that the tubular portion 31 is not necessarily required. In addition, the filtration member 32 is not limited to a wire mesh, and may be a pleated filtration member formed by pleating a net-like member such as a mesh.

The upper end member 33 is provided at upper ends of the tubular portion 31 and the filtration member 32. The upper end member 33 includes a recessed portion 33a into which the tubular portion 31 and the filtration member 32 are inserted, and a plate-like portion 33b covering a hollow portion of the recessed portion 33a. Therefore, the hydraulic oil cannot pass through the upper end member 33.

The lower end member 34 is provided at lower ends of the tubular portion 31 and the filtration member 32. The lower end member 34 includes a recessed portion 34a into which the tubular portion 31 and the filtration member 32 are inserted. The inner side of the recessed portion 34a is a hollow portion 34b through which the hydraulic oil can pass.

Arrows in FIGS. 6 and 7 indicate the flow of hydraulic oil. The hydraulic oil flowing from the space S1 into the space S2 flows from the outer side toward the inner side of the filter element 11, thereby being filtered and flowing into the space S3. The filtered hydraulic oil flows downward from the space S3 into the spaces S4 and S5.

Apart of the hydraulic oil flowing into the space S5 flows out into the tank 100 via the holes 121d in accordance with the flow volume (for example, when the flow volume flowing into the tank 100 is large), but a large part of the hydraulic oil flows into the space S6. Since the third filtration unit 30A is provided in the space S6, the hydraulic oil flowing into the space S6 flows through the filtration member 22 into the tank 100. Meanwhile, when the flow volume of the hydraulic oil flowing into the tank 100 decreases while the hydraulic circuit is operating, the hydraulic oil stored in the tank 100 flows through the filtration member 22 into the space S6.

When the hydraulic oil flowing into the space S6 passes through the filtration member 32, air bubbles are removed, and the hydraulic oil flows into a hollow portion (space S7) of the third filtration unit 30A. The hydraulic oil flowing into the space S7 flows out from the filter device 2 through the hollow portion 24c to be guided to the pump of the hydraulic circuit.

According to the present embodiment, the third filtration unit 30A is provided so as to cover the hollow portion 24c, and thus the outflow of air bubbles contained in the hydraulic oil can be prevented. In addition, since the hollow portion (space S6) of the second filtration unit 20B is wide, the flexibility in shape of the third filtration unit 30A is increased. For example, the third filtration unit 30A can be a pleated filtration member as in the present embodiment, or can have a plate-like shape.

Further, according to the present embodiment, the filtration member 32 is a pleated filtration member, and thus the filtration area can be increased and a pressure loss can be reduced.

Note that in the present embodiment, the filtration member 32 made of a pleated wire net is provided so as to cover the hollow portion 24c, but the form of the filtration member 32 is not limited such a form. For example, a filtration member formed by connecting both ends of a plate-like wire net into a tubular shape may be provided so as to cover the hollow portion 24c. Note that the filtration area can be further increased by using a pleated filtration member as the filtration member 32. Alternatively, a plate-like filtration member may be provided so as to cover the hollow portion 24c.

Furthermore, in the present embodiment, the filter device 2 includes the third filtration unit 30A provided on the lower end member 24A; however, the filter device 2 may include the third filtration unit 30 and the third filtration unit 30A. In other words, the filter device may include a plurality of third filtration units.

### First Modified Example of Second Embodiment

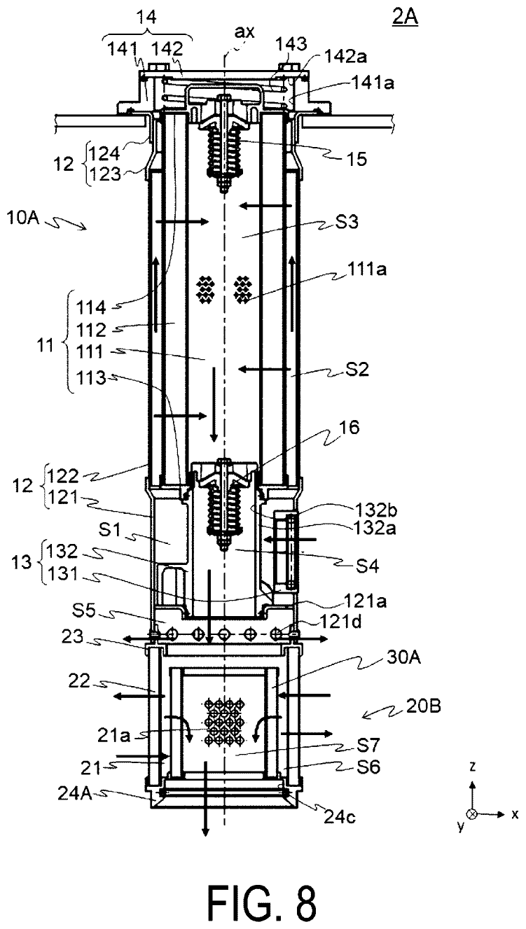

FIG. 8 is a cross-sectional view illustrating an overview of a filter device 2A according to a modified example. In FIG. 8, hatching indicating a cross-section is omitted. The filter device 2A is different from the filter device 2 in that the exhaust pressure valve 16 is provided. Note that descriptions of the same components as those in the filter devices 1A and 2 will be omitted.

The filter device 2A mainly includes the first filtration unit 10A, the second filtration unit 20B, and the third filtration unit 30A. Since the first filtration unit 10A includes the exhaust pressure valve 16, the oil filtered in the filter device 2A can flow to the pump at a constant pressure when the flow volume increases during operation of the hydraulic device.

### Third Embodiment

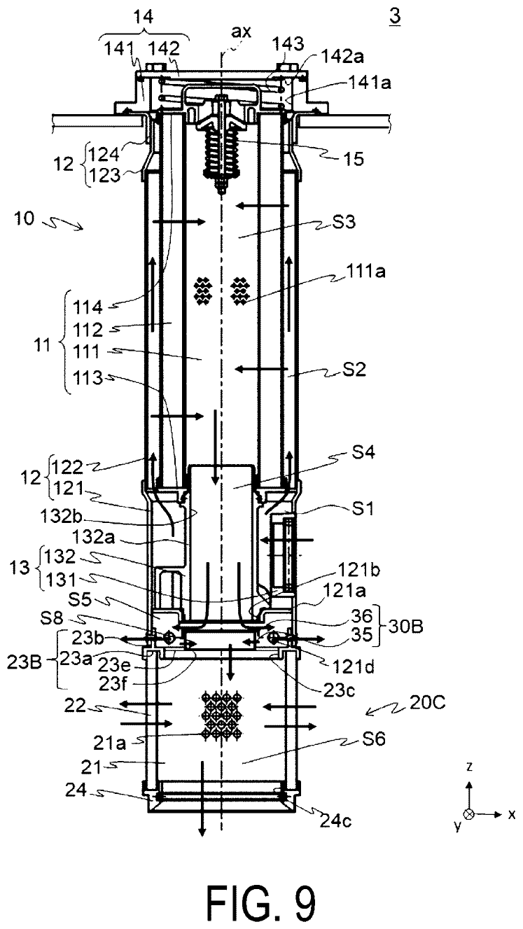

FIG. 9 is a cross-sectional view illustrating an overview of a filter device 3 according to a third embodiment. In FIG. 9, hatching indicating a cross-section is omitted. Note that descriptions of the same components as those in the filter device 1 will be omitted.

The filter device 3 mainly includes the first filtration unit 10, a second filtration unit 20C, and a third filtration unit 30B. The third filtration unit 30B is provided on the second filtration unit 20C.

The second filtration unit 20C mainly includes the tubular portion 21, the filtration member 22, an upper end member 23B, and the lower end member 24.

The upper end member 23B is provided at the upper ends of the tubular portion 21 and the filtration member 22. The upper end member 23B includes the recessed portion 23a into which the tubular portion 21 and the filtration member 22 are inserted, the tubular portion 23b provided on the recessed portion 23a, and a mounting portion 23e. The mounting portion 23e is a member to which the third filtration unit 30B is mounted, and is provided in the hollow portion 23c. A hole 23f (corresponding to the second flow path of the present invention) is formed in the mounting portion 23e.

The third filtration unit 30B is provided so as to cover the hole 23f. The space outside the third filtration unit 30B is the space S5, and the space inside the third filtration unit 30B is a space S8.

The third filtration unit 30B mainly includes a filtration member 35 and an upper end member 36. The filtration member 35 is formed in a tubular shape by connecting both ends of a net-like member such as a wire net or mesh. The mesh of the filtration member 35 is as fine as the mesh of the filtration member 22 or finer than the mesh of the filtration member 22. In the present invention, the term “tubular shape” is not limited to a cylinder having a circular cross-sectional shape in a plane orthogonal to the axis. For example, the cross-sectional shape of the filtration member 35 in a plane orthogonal to the axis may be a polygonal shape, an elliptical shape, or the like.

The upper end member 36 is provided at an upper end of the filtration member 35. The upper end member 36 covers a hollow portion of the filtration member 35. Therefore, the hydraulic oil cannot pass through the upper end member 36.

A lower end of the filtration member 35 is provided on the mounting portion 23e. In plan view, the hole 23f is located at a position overlapping the filtration member 35 or on the inner side of the filtration member 35. For example, the lower end of the filtration member 35 is provided along the peripheral edge of the hole 23f.

Arrows in FIG. 9 indicate the flow of hydraulic oil. The hydraulic oil flowing into the space S1 flows from the outer side toward the inner side of the filter element 11, thereby being filtered and flowing into the space S3. The filtered hydraulic oil flows downward and flows through the space S3 and the space S4 into the space S5.

When the hydraulic oil flowing into the space S5 passes through the filtration member 35, air bubbles are removed, and the hydraulic oil flows through the space S8 into the space S6. Thereafter, the hydraulic oil flows out from the filter device 3 through the hollow portion 24c to be guided to the pump of the hydraulic circuit.

According to the present embodiment, the third filtration unit 30B is provided so as to cover the hole 23f, and thus the outflow of air bubbles contained in the hydraulic oil can be prevented. In addition, by forming the filtration member 35 in a tubular shape, the filtration area can be increased as compared with the plate-like third filtration unit 30.

Note that the filter device 3 of the present embodiment does not include an exhaust pressure valve, but may be provided with an exhaust pressure valve. For example, the second filtration unit 20A including the exhaust pressure valve 25 may be used instead of the second filtration unit 20C.

### Fourth Embodiment

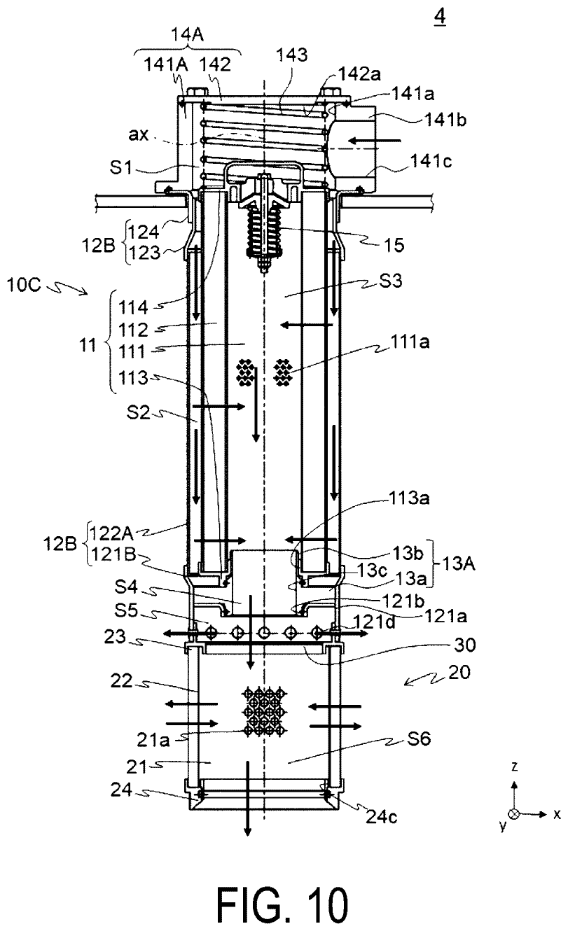

FIG. 10 is a cross-sectional view illustrating an overview of a filter device 4 according to a fourth embodiment. In FIG. 10, hatching indicating a cross-section is omitted. The filter device 4 is characterized in that the inflow portion is provided in the lid member as compared with the filter device 1 of the first embodiment. Note that descriptions of the same components as those in the filter device 1 will be omitted.

The filter device 4 mainly includes a first filtration unit 10C, the second filtration unit 20, and the third filtration unit 30. The first filtration unit 10C includes the filter element 11, a filter case 12B, an inner part 13A, a lid member 14A, and the valve 15.

The filter case 12B is a member having a tubular shape (here, substantially cylindrical shape) as a whole, and is formed of metal. The filter case 12B mainly includes a first case 121B, a second case 122A, and the mounting members 123 and 124. The first case 121B and the first case 121, and the second case 122A and the second case 122 have different heights in the z-direction.

The inner part 13A is provided inside the first case 121B. The inner part 13A is provided on a plate-like portion 121a so as to close a hollow portion of the first case 121B, and divides the inside of the first case 121B into three spaces S2, S4, and S5. The space above the plate-like portion 121a and the inner part 13A is the space S2, and the space below the plate-like portion 121a and the inner part 13A is the space S5.

The inner part 13A mainly includes a plate-like portion 13a and a tubular portion 13b. The plate-like portion 13a is provided along the plate-like portion 121a, and the plate 113 is in contact with the plate-like portion 13a.

The tubular portion 13b extends along the center axis ax, and a hollow portion 13c of the tubular portion 13b is the space S4. The hollow portion 13c extends through the tubular portion 13b, i.e., the inner part 13A. The inner part 13A and the first case 121B that form the spaces S4 and S5 are an outflow portion (corresponding to the first outflow portion of the present invention) through which the fluid filtered by the filter element 11 flows out.

A lower end of the tubular portion 13b is inserted into the hole 121b. In addition, the tubular portion 13b is inserted into the opening 113a, and thus an upper end of the tubular portion 13b is inserted into the filter element 11. Therefore, the hollow portion 13c (space S4) allows the space S3 and the space S5 to communicate with each other.

The lid member 14A is a substantially plate-like member that covers an open end of an upper portion of the filter case 12B. The lid member 14A is detachably provided on the filter case 12B (here, the mounting member 124). The filter element 11 is provided inside the filter case 12B and the lid member 14A (that correspond to the case of the present invention).

The lid member 14A includes a first lid 141A and the second lid 142. The first lid 141A has a substantially cylindrical shape, and the hollow portion 141a is formed therein. Further, a tubular portion 141b is provided on a side surface of the first lid 141A, and the hydraulic oil flows into the space S1 from the hollow portion 141c of the tubular portion 141b. The tubular portion 141b is an inflow portion (corresponding to the first inflow portion of the present invention) through which the fluid flows into the filter case 12B.

Arrows in FIG. 10 indicate the flow of hydraulic oil. The hydraulic oil flows into the space S1 (here, the hollow portion 141a) through the tubular portion 141b (the hollow portion 141c). The hydraulic oil flows from the space S1 into the space (space S2) outside the filter element 11 and flows from the outer side toward the inner side of the filter element 11, thereby being filtered and flowing into the space S3. The filtered hydraulic oil flows downward from the space S3 into the spaces S4 and S5.

Apart of the hydraulic oil flowing into the space S5 flows out into the tank 100 through the holes 121d depending on the flow volume, but a large part of the hydraulic oil flows into the space S6. At this time, the hydraulic oil passes through the third filtration unit 30. At this time, air bubbles in the hydraulic oil are removed.

A part of the hydraulic oil passing through the third filtration unit 30 and then flowing into the space S6 flows out into the tank 100 via the filtration member 22 or flows in from the tank 100 depending on the flow volume; however, a large part of the hydraulic oil flows out from the filter device 1 through the hollow portion 24c. The hydraulic oil flowing out from the filter device 1 is guided to a pump of the hydraulic circuit.

According to the present embodiment, similarly to the filter device 1, the third filtration unit 30 is provided so as to cover the hollow portion 23c, and thus the outflow of air bubbles contained in the hydraulic oil can be prevented.

### First Modification of Fourth Embodiment

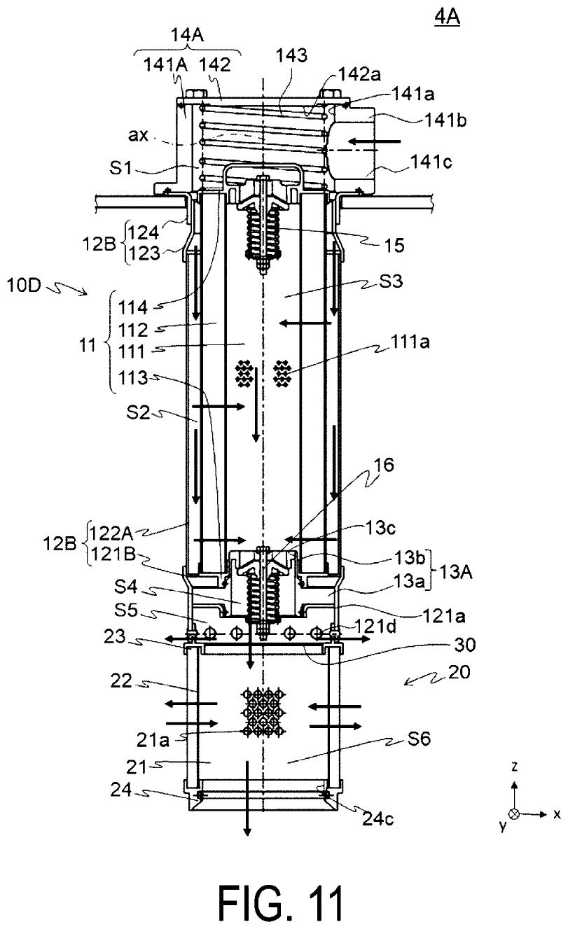

FIG. 11 is a cross-sectional view illustrating an overview of a filter device 4A according to a modified example. The filter device 4A is different from the filter device 4 in that the exhaust pressure valve 16 is provided. In FIG. 11, hatching indicating a cross-section is omitted. Note that descriptions of the same components as those in the filter devices 1, 1A, and 4 will be omitted.

The filter device 4A mainly includes a first filtration unit 10D, the second filtration unit 20, and the third filtration unit 30. The first filtration unit 10D includes the filter element 11, the filter case 12B, the inner part 13A, the lid member 14A, the valve 15, and the exhaust pressure valve 16.

The exhaust pressure valve 16 is provided in the tubular portion 13b so as to cover the hollow portion 13c. This allows the oil filtered in filter device 4A to flow to the pump at a constant pressure when the flow volume increases during operation of the hydraulic device.

Note that in the filter device 4A including the exhaust pressure valve 16, the lid member 14A may be provided with a tubular portion (not illustrated) different from the tubular portion 141b. The tubular portion is an outflow portion (corresponding to a second outflow portion of the present invention) through which the hydraulic oil flowing into the space S1 flows out through the tubular portion 141b. The hydraulic oil flowing out from the hollow portion 24c is guided to a main pump. Meanwhile, the hydraulic oil flowing out from the outflow portion is guided to a pump such as a charge pump, which is different from the main pump.

### Second Modification of Fourth Embodiment

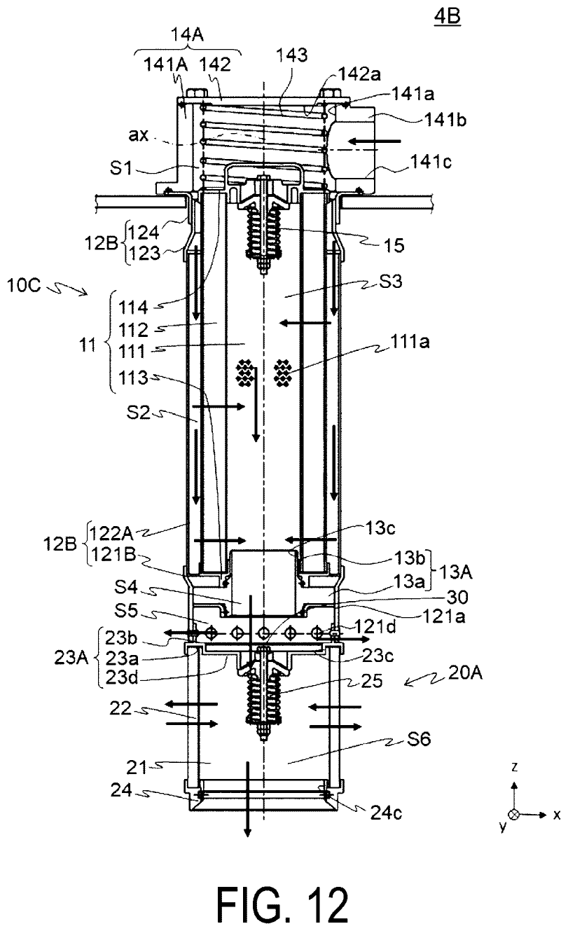

FIG. 12 is a cross-sectional view illustrating an overview of a filter device 4B according to a modified example. The filter device 4B is different from the filter device 4 in that the exhaust pressure valve 25 is provided. In FIG. 12, hatching indicating a cross-section is omitted. Note that descriptions of the same components as those in the filter devices 1, 1B, and 4 will be omitted.

The filter device 4B mainly includes the first filtration unit 10C, the second filtration unit 20A, and the third filtration unit 30. The provision of the exhaust pressure valve 25 in the second filtration unit 20A allows the oil filtered in the filter device 4B to flow to the pump at a constant pressure when the flow volume increases during operation of the hydraulic device.

Note that similarly to the filter device 4A, in the filter device 4B including the exhaust pressure valve 25, the lid member 14A may be provided with a tubular portion (corresponding to a third outflow portion of the present invention) different from the tubular portion 141b.

### Fifth Embodiment

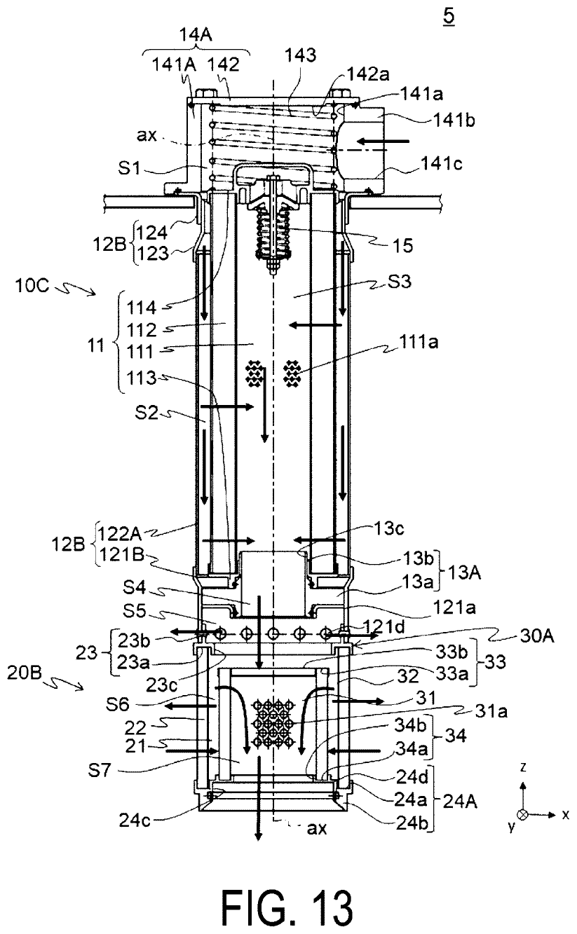

FIG. 13 is a cross-sectional view illustrating an overview of a filter device 5 according to a fifth embodiment. In FIG. 13, hatching indicating a cross-section is omitted. The filter device 5 is characterized in that the inflow portion is provided in the lid member as compared with the filter device 2 of the second embodiment. Hereinafter, descriptions of the same components as those in the filter devices 1 to 4 will be omitted.

The filter device 5 mainly includes the first filtration unit 10C, the second filtration unit 20B, and the third filtration unit 30A.

According to the present embodiment, similarly to the filter device 2, the third filtration unit 30A is provided so as to cover the hollow portion 24c, and thus the outflow of air bubbles contained in the hydraulic oil can be prevented.

### First Modified Example of Fifth Embodiment

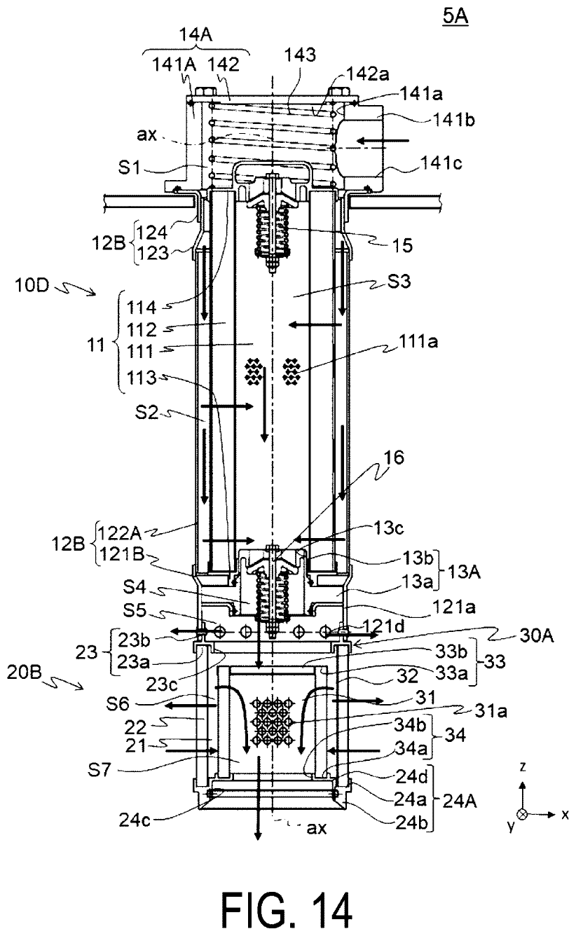

FIG. 14 is a cross-sectional view illustrating an overview of a filter device 5A according to a modified example. In FIG. 14, hatching indicating a cross-section is omitted. The filter device 5A is different from the filter device 5 in that the exhaust pressure valve 16 is provided. The filter device 5A mainly includes the first filtration unit 10D, the second filtration unit 20B, and the third filtration unit 30A. The exhaust pressure valve 16 allows the oil filtered in the filter device 5A to flow to the pump at a constant pressure when the flow volume increases during operation of the hydraulic device.

### Sixth Embodiment

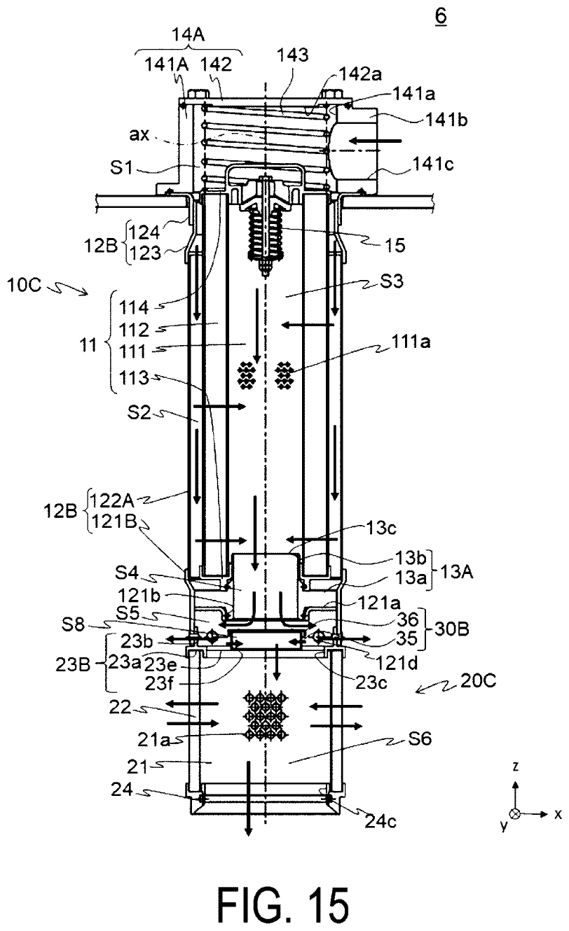

FIG. 15 is a cross-sectional view illustrating an overview of a filter device 6 according to a sixth embodiment. In FIG. 15, hatching indicating a cross-section is omitted. The filter device 6 is characterized in that the inflow portion is provided in the lid member as compared with the filter device 3 of the third embodiment. Hereinafter, descriptions of the same components as those in the filter devices 1 to 4 will be omitted.

The filter device 6 mainly includes the first filtration unit 10C, the second filtration unit 20C, and the third filtration unit 30B. The third filtration unit 30B is provided on the second filtration unit 20C.

According to the present embodiment, similarly to the filter device 3, the third filtration unit 30B is provided so as to cover the hole 23f, and thus the outflow of air bubbles contained in the hydraulic oil can be prevented.

The embodiments of the present invention are described above in detail with reference to the drawings. However, specific configurations are not limited to the embodiments and also include design changes or the like without departing from the scope of the invention. For example, in the examples described above, detailed description is made to facilitate understanding of the present invention, and the examples are not necessarily limited to examples including all the configurations described above. Further, the configuration of an embodiment can be partially replaced with the configurations of other embodiments. Furthermore, addition, deletion, replacement, or the like of other configurations can be made on the configurations of the embodiments.

Additionally, in the present invention, the term “substantially” is a concept not only including the case of being strictly the same, but also including error and deformation to the extent that a loss of identity does not occur. For example, the term “substantially orthogonal” is not limited to the case of being strictly orthogonal, but includes a concept that includes a margin of error of, for example, several degrees. Moreover, the case in which, for example, orthogonal, parallel, identical, or the like is simply expressed includes not only the case of being strictly orthogonal, parallel, identical, or the like, but also the case of being substantially parallel, substantially orthogonal, substantially identical, or the like.

Additionally, in the present invention, the term “vicinity” means to include a certain range (the range can be determined arbitrarily) of the region located near a reference position. For example, the term “a location near an end” refers to a certain range of the region located near the end, and is a concept indicating that the end may be included or need not be included.

### REFERENCE SIGNS LIST

1, 1A, 1B, 2, 2A, 3, 4, 4A, 4B, 5, 5A, 6: Filter device
10, 10A, 10C, 10D: First filtration unit
11: Filter element
12, 12B: Filter case
13, 13A: Inner part
13a: Plate-like portion
13b: Tubular portion
13c: Hollow portion
14, 14A: Lid member
15: Valve
16: Exhaust pressure valve
20, 20A, 20B, 20C: Second filtration unit
21: Tubular portion
21a: Hole
22: Filtration member
23, 23A, 23B: Upper end member
23a: Recessed portion
23b: Tubular portion
23c: Hollow portion
23d: Mounting portion
23e: Mounting portion
23f: Hole
24, 24A: Lower end member
24a: Recessed portion
24b: Tubular portion
24c: Hollow portion
25: Exhaust pressure valve
30, 30A, 30B: Third filtration unit
31 Tubular portion
31a: Hole
32, 35: Filtration member
33, 36: Upper end member
33a: Recessed portion
33b Plate-like portion
34: Lower end member
34a: Recessed portion
34b: Hollow portion
100: Tank
101: Tank body
101a: Upper surface
101b: Hole
101c: Bottom surface
101b: Hole
110: Tank
111: Inner tube
111a: Hole
112: Filtration member
113, 114: Plate
113a: Opening
121, 121B: First case
121a: Plate-like portion
121b, 121c, 121d: Hole
122, 122A: Second case
123, 124: Mounting member
131: First part
132: Second part
132a: Tubular portion
132b: Hollow portion
132c: Protruding portion
141, 141A: First lid
141a: Hollow portion
141b: Tubular portion
141c: Hollow portion
142: Second lid
142a: Lower surface
143: Elastic member

1. A filter device comprising:
a first filtration unit;
a second filtration unit provided below the first filtration unit to overlap the first filtration unit in plan view; and
a third filtration unit provided in the first filtration unit or the second filtration unit,
wherein
the first filtration unit includes
a case;
a first inflow portion provided in the case and through which a fluid flows into the case;
a first filter element through which the fluid passes to be filtered, the first filter element having a tubular shape and disposed inside the case, and
a first outflow portion provided in the case and including a first flow path through which the fluid filtered by the first filter element flows out from the first filtration unit,
the second filtration unit includes
a second filter element having a tubular shape and disposed inside a tank,
a second inflow portion provided between the first outflow portion and the second filter element and including a second flow path that allows the first flow path and a hollow portion of the second filter element to communicate with each other, and
a second outflow portion provided below the second filter element and including a third flow path that allows the hollow portion of the second filter element and an outside of the second filter element to communicate with each other, and
the third filtration unit includes a filtration part that covers at least one of the first flow path, the second flow path, or the third flow path.

2. The filter device according to claim 1, wherein
the second filtration unit includes an upper end member provided on an upper end side of the second filter element,
the second flow path is formed in the upper end member, and
the third filtration unit is formed of a net-like member having a plate shape and is provided on the upper end member to cover the second flow path.

3. The filter device according to claim 1, wherein
the second outflow portion includes a lower end member provided on a lower end side of the second filter element,
the third flow path is formed in the lower end member, and
the third filtration unit is provided in a hollow portion of the second filtration unit to cover the third flow path.

4. The filter device according to claim 3, wherein
the filtration part is a member obtained by forming a net-like member into a tubular shape,
the third filtration unit includes a plate covering one end of the filtration part, and
an end of the filtration part on a side at which the plate is not disposed is provided on the lower end member.

5. The filter device according to claim 1, comprising:
an exhaust pressure valve provided in the first filtration unit or the second filtration unit,
wherein
the case includes a filter case and a lid member at which an upper side of the filter case is provided, and
the lid member includes the first inflow portion and a third outflow portion through which a hydraulic oil flowing through the first inflow portion to an inner part of the lid member flows out.

6. A filtration device comprising:
a tank;
a first filtration unit provided to protrude from an upper surface of the tank into the tank;
a second filtration unit provided below the first filtration unit to overlap the first filtration unit in plan view;
a third filtration unit provided in the first filtration unit or the second filtration unit,
wherein
the first filtration unit includes
a case,
a first inflow portion provided in the case and through which a fluid flows into the case,
a first filter element through which the fluid passes to be filtered, the first filter element having a tubular shape and disposed inside the case, and
a first outflow portion provided in the case and including a first flow path through which the fluid filtered by the first filter element flows out from
the first filtration unit,
the second filtration unit includes
a second filter element having a tubular shape and disposed inside the tank;
a second inflow portion provided between the first outflow portion and the second filter element and including a second flow path that allows the first flow path and a hollow portion of the second filter element to communicate with each other, and
a second outflow portion provided below the second filter element and including a third flow path that allows the hollow portion of the second filter element and an outside of the second filtration unit to communicate with each other, and
the third filtration unit includes a filtration part that covers at least one of the first flow path, the second flow path, or the third flow path.

7. The filter device according to claim 2, comprising:
an exhaust pressure valve provided in the first filtration unit or the second filtration unit,
wherein
the case includes a filter case and a lid member at which an upper side of the filter case is provided, and
the lid member includes the first inflow portion and a third outflow portion through which a hydraulic oil flowing through the first inflow portion to an inner part of the lid member flows out.

8. The filter device according to claim 3, comprising:
an exhaust pressure valve provided in the first filtration unit or the second filtration unit,
wherein
the case includes a filter case and a lid member at which an upper side of the filter case is provided, and
the lid member includes the first inflow portion and a third outflow portion through which a hydraulic oil flowing through the first inflow portion to an inner part of the lid member flows out.

9. The filter device according to claim 4, comprising:
an exhaust pressure valve provided in the first filtration unit or the second filtration unit,
wherein
the case includes a filter case and a lid member at which an upper side of the filter case is provided, and
the lid member includes the first inflow portion and a third outflow portion through which a hydraulic oil flowing through the first inflow portion to an inner part of the lid member flows out.
